(19) United States
(12) Patent Application Publication
(10) Pub. No.: US 2008/0023960 A1
(43) Pub. Date: Jan. 31, 2008

(54) SANITARY QUICK CONNECTOR

(76) Inventor: George Carmichael, Rindge, NH (US)

Correspondence Address: Vern Maine & Associates, 100 MAIN STREET, P O BOX 3445, NASHUA, NH, 03061-3445, US

(21) Appl. No.: 11/828,407

(22) Filed: Jul. 26, 2007

Related U.S. Application Data
(60) Provisional application No. 60/820,650, filed on Jul. 28, 2006.

(51) Int. Cl. F16L 19/00

(52) U.S. Cl. 285/342

(57) ABSTRACT

A sanitary fluid connector system for joining a sanitary fluid system terminated by a first sanitary fluid connector fitting to an industry standard, flanged end, sanitary fluid connector fitting so as to confine fluid contact to the fittings and avoid fluid entrapment in the connector. A tubular connector body is configured to removably secure the first fluid conducting component to the sanitary fluid connector fitting. The connector body is adjustably engaged with the mating end of the first fluid conducting component for setting the depth of engagement. A coupling end of the connector body has an externally operated eccentric cam locking mechanism by which a mating flange on one end of the second sanitary fluid fitting is releasably secured to the mating face of the first sanitary fluid fitting within the connector body, with an industry standard gasket therein between.

### RELATED APPLICATIONS

This application claims the benefit of U.S. Provisional Applications No. 60/820,650, filed Jul. 28, 2006 and is herein incorporated in its entirety by reference.

### FIELD OF INVENTION

The invention relates to quick connectors for connecting sanitary fluid systems to sanitary fittings, and, more particularly, to ISO 2852, ASME BPE, and 3-A sanitary hygienic fittings.

### BACKGROUND OF INVENTION

Sanitary couplings are used in food processing, dairy, beverage, pharmaceutical, and biotechnology industries, where fluid lines are required to be joined by abutting unions of sanitary fittings so that fluid entrapment within parts of the connector body does not occur. Common sanitary fluid couplers rely on manual clamps to secure components together, as is illustrated in prior art FIG. 6. These can be complicated assemblies that are often difficult to assemble by one person and may cause or contribute to repetitive motion injuries. The fittings are also prone to being applied with only partial engagement, resulting in joint leakage or even separation. Various industry standards including ISO 2852, ASME BPE, and 3-A define the geometry and properties of “sanitary” fittings.

### SUMMARY OF INVENTIONS

The invention, simply stated, is a mechanism and method for quickly coupling and uncoupling a sanitary fluid system to a sanitary fitting such as one that terminates a fluid port or manifold or another fluid line, where fluid flow is sealed against contact with the coupling mechanism or structure. It may be referred to as a sanitary connector or coupling. Specifications for fluid handling systems in sanitary processing usually consist of stainless steel tubing connected by a series of sanitary fittings. These fittings, referring again to prior art FIG. 6, require awkward posture to assemble and disassemble and increase the risk of repetitive motion injuries.

It is a goal of the invention to provide a single side coupling connector to provide for making a sanitary coupling to existing ISO, ASME BPE, and 3-A sanitary fittings, that is quick and easy to connect and disconnect, and otherwise meets industry requirements for sanitary devices. To that end, connectors of the invention are easily disassembled for cleaning, and connect directly to all ASME BPE, ISO 2852, and 3-A sanitary fittings with one handed operation.

One example of the invention includes a first hose or tube fitting that conforms to industry standards for a sanitary fluid flow and has a mating surface suitable for mating with a standard flanged sanitary fitting. This component is combined with a connector body and cam lock system, the purpose of which is to provide for quick coupling and uncoupling of the first fitting to an industry standard, flanged sanitary fluid fitting, referred to herein as the second fitting. The joint or union can be described as a sealed, first fitting face, to a conforming industry standard gasket, and hence to a second fitting face with an abutting orientation, so that the coupler body and its components are isolated from fluid contact, all according to the applicable industry standards.

There may be an axially adjustable connection between the connector body and the first fitting, external of the fluid path, which affects the degree of compression placed on the union of the two fittings by the coupler when locked. It can be described and used as an initial adjustment prior to coupling to obtain a satisfactory initial degree of compression between the fittings, and/or used to adjust the compression after the connector is coupled to the selected second fitting. In operation, a quick connector of the invention which may be installed, for example, on the end of a flexible fluid line, is manipulated to be placed over and be secured to a second industry standard, flanged sanitary fluid fitting by its cam lock mechanism in a compressive connection. The cam lock action that secures the coupling is accomplished by a simple, manual, closing lever action motion that rotates a pair or more of cams into pulling contact against the backside of the flange on the second sanitary fitting. The cam levers may be securable in their “locked” position such as by respective pins or other means to inhibit unintended release of the cam lock. Disconnecting the fluid line and connector from the sanitary fitting is simply the same action in reverse; releasing the lever lock if applicable, executing an opening lever action to unlock and retract the cams, then pulling apart of the connector body and fluid line from the second fitting.

The cam lock mechanism that secures the compressed connection between the two fluid conducting fittings is created by two or more eccentric cams that pull on the back side of the external flange on the second fitting and thereby compressing the gasket and locking the second fitting against the first fitting with the compressed gasket there between.

The features and advantages described herein are not necessary to every embodiment, and many additional features and advantages within the scope of the invention will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of one embodiment of a sanitary quick connector with cam levers and cams in the coupled or locked position.

FIG. 2 is a cross sectional view of another embodiment of a sanitary quick connector shown mated with and coupled to a flanged sanitary fitting.

FIG. 3 is a cross sectional view of one embodiment of a sanitary quick connector mated with a flanged sanitary fitting but unlocked and not secured by the cams.

FIG. 4 is an axial view of a sanitary quick connector, looking through the sanitary fitting to which it is coupled.

FIG. 5 is a close up view of a cam mechanism of one embodiment of a sanitary quick connector shown locked onto the flange of a sanitary fitting.

FIG. 6 is a perspective view of a prior art sanitary fluid flow connector, gasket and two fittings that together comprise a sanitary union.

### DETAILED DESCRIPTION

The invention is susceptible of many embodiments. What is described and illustrated is intended to be illustrative but not limiting of the scope of the invention.

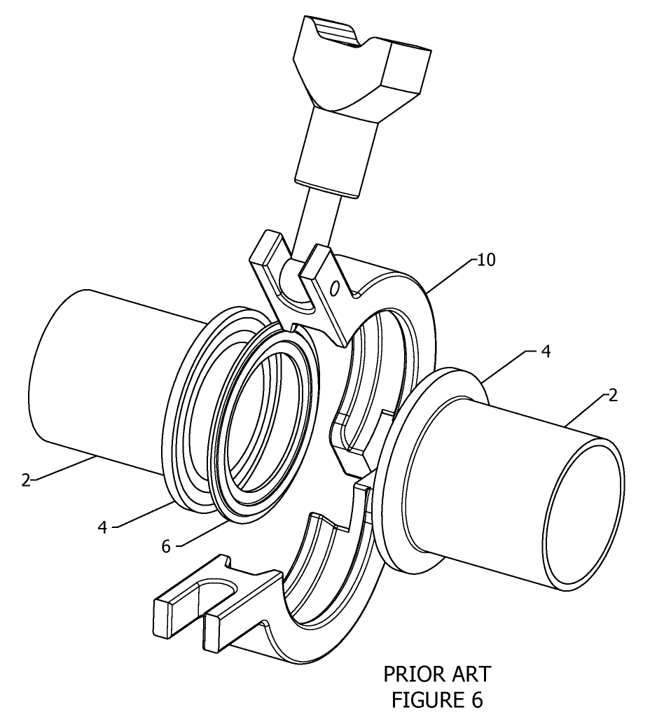

Referring to FIG. 6, a prior art sanitary connector assembly is shown in an exploded perspective view, where two sanitary fittings 2, configured with butt end flanges 4, are jointed face to face with a sanitary gasket 6 therein between. Gasket 6 has a cross section profile conforming to the profile of the faces of sanitary fittings 2. The fittings, with the gasket therein between, are clamped together by their flanges 4 by clamp 10, so as to form a face to face compression joint or union.

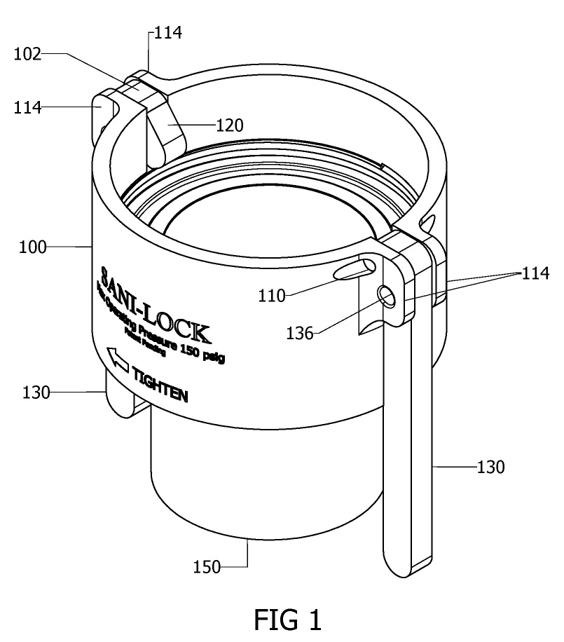

Now referring to FIGS. 1-5 generally, a quick connect and disconnect fluid connection system in one embodiment has a connector body 100 as shown, circular in these examples, enclosing the abutting ends of a first fitting 150 and an externally flanged second fitting 160. The fluid may be liquid or gas or a blend or mix of materials. The fluid may include solids or semi-solids mixed with or in suspension in the fluid. The fluid may be a food or agricultural product or a chemical or pharmaceutical product or other fluid for which sanitary handling or processing conditions are required.

Second fitting 160 is a very specific, existing structure, its geometry being defined by industry standards for sanitary fittings as a flanged sanitary fitting having a flat end or face with a gasket recess that is designed for making a face to standard gasket to face, or gasketed butt joint union with another fitting of similar mating geometry, as with an appropriate gasket or seal and a mating fitting and/or coupler or sanitary fluid connector of the invention. The term “second fitting” or “fitting 160”, in the description that follows refers to fittings conforming to an industry standard geometry for sanitary fittings, in its various scaled sizes. Minor variations from the standard or to the standard, such as a small change to the angle of the backside of the flange or a change to the axial length or wall thickness of the flange, or the introduction of fittings on a larger or smaller scale, are within the scope of the invention and claims.

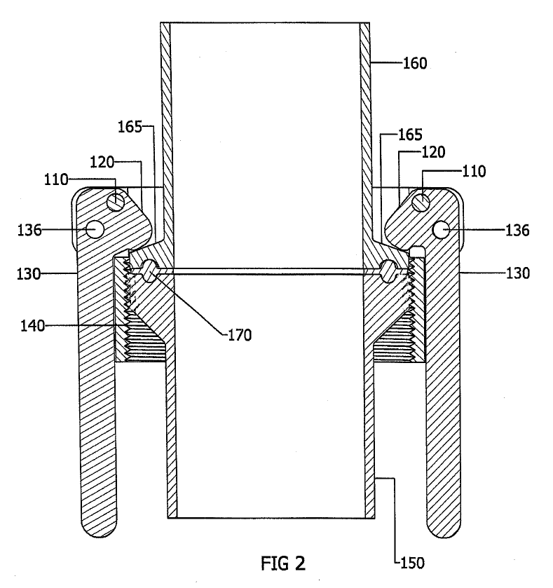

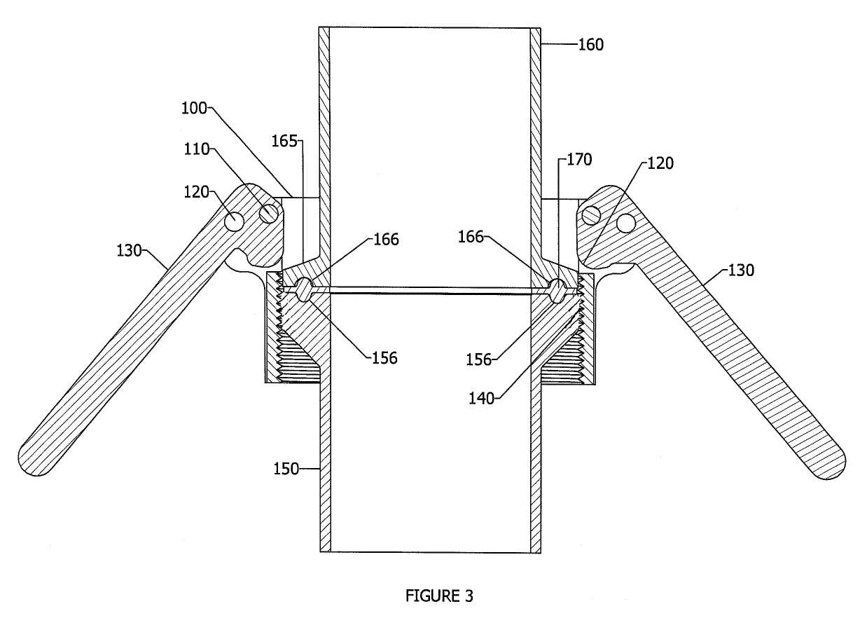

In the examples of FIGS. 2 and 3, first fitting 150 is secured within one end of body 100 by a threaded connection although other means of connection between the first fitting and the connector may be used. The back end of first fitting 150 may be adapted as by raised ribs for attachment of a fluid line or hose, commonly secured by a hose clamp or the like. In other examples, first fitting may be incorporated into the end of a pipe or a manifold, or fluid vessel of some sort, be it a source, holding tank or repository. The other end of connector body 100 is configured with two opposing slots 102, which in this case are U-shaped or open ended slots, although they may in other embodiments be regular or irregularly shaped holes in the wall of body 100, suitable the purpose described. The slots 102 are axially oriented in this example to be longer than they are wide; although in other embodiments, the shape of the slot or hole may vary with the shape of their associated cam structures. Respective eccentric cams 120 are hingedly installed within or proximate to slots 102 so that their respect cam surfaces are inwardly exposed for securing engagement with another surface. Cam levers 130 extend outboard from the cam hinge line and connector body for manual operation of the cams. The two slots and cams are equally spaced around the circumference of connector body 100. There may be more than two slots and cams in some embodiments and the spacing between them may vary.

Eccentric cams 120 and respective cam levers 130 are outwardly rotable up to about 180 degrees on their respective pivot pins 110 between a closed and locked position laying closely adjacent to the wall of body 100 and first fitting 150, and an open position that is visually distinctive from the closed position, where levers 130 may range from about 30 or 40 degrees to generally orthogonal or more, up to 180 degrees from locked, where they may lay adjacent to second fitting 160 when coupled thereto, depending on the geometry of the cam mechanism.

The travel of levers 130 may be intentionally limited to or have an operating range of less than 180 degrees. Their range of motion may be biased by springs and/or detents of one kind or another to retain them in a preferred open or closed position. Pivot pins 110 may be separate components installed through hinge pin holes in cams 120 and secured within hinge pin supports 114 on either side of respective slots 102. Alternatively, pins 110 may be shaft-like extensions integral to and extending from each side of each cam 120 into the hinge pin supports. Other common means of hingedly securing a rotational component to a body in the manner of attaching cams 120 to body 100 so as to operate within and through slots 102 are within the scope of the invention.

Additionally there are locking holes 106 provided in supports 114 and corresponding locking holds 136 in cam levers 130, for securing cam levers 130 in the locked or coupled position. Locking holes or other means for securing the levers in a desired position are optional in other embodiments.

A sanitary quick connector of the invention in use normally includes a body 100 mated to a fitting 150, installed on one end of a flexible fluid tube or line (not shown) with the desired axial adjustment or pre-adjustment depth of fitting 150 set within body 100 to result in a desired amount of compressive closing force on the flanged end of the selected second sanitary fitting. Cam levers 130 will be folded against body 100 as in FIGS. 1 and 2, with their ends extending axially in the direction of fitting 150. Cams 120 protrude into the interior of body 100 through slots 102. In some embodiments the sanitary quick connector cannot be mated to a sanitary second fitting, in this case sanitary fitting 160, until the cam mechanism is manually opened. In other embodiments, during the application of the connector body to a flanged second fitting 160 while attempting to make a connection, the incoming flange of the second fitting may tend push the cams open until the flange is past the cam and abutted against the first fitting, whereafter the cams can be closed by the previously described normal lever action closing motion, to bring compression to the union.

In the former instance, to prepare the coupling for mating with fitting 160, levers 130 must be rotated to the open position, where eccentric cams 120 are retracted from the interior volume of the connector body so as to allow or provide sufficient clearance for the external flange on the end of fitting 160 to be inserted into the connector body to form a butt joint with first fitting 150. In the later instance, the levers 130 will simply be rotated open as the cams are pushed outward by incoming flange 165. In the open position, levers 130 will be at least 30 degrees and may be between 30 and 180 degrees away from their closed position against body 100, with ends extending towards fitting 150, depending on the design details of specific embodiments. Further, in some embodiments, cams 120 may be spring loaded to yield to receive the flange of a sanitary second fitting during a coupling action, and return by spring pressure to the locked position once the flange is within the grasp of cams 120.

The butt joint interface is prepared in advance of closing with an industry standard sanitary seal or gasket 170. As described above, the seal or gasket may be a single or multiple component device and may have been installed or pre-positioned on the face end of either or both fittings 150 and 160 prior to making the connection.

Still referring to the embodiment of FIG. 3, closure of cam levers 130, whereby the levers are rotated with respect to body 100 in the direction of attached fitting 150, brings eccentric cams 120 into axially compressive contact with the back side or cam contact side of flange 165 of fitting 160, so as to secure the butt joint with sufficient axially compressive force to form and maintain the integrity of the butt joint seal against a maximum industry standard working fluid pressure, which in typical applications for sanitary quick disconnect fittings is about 80 psi (pounds per square inch). Higher and lower pressures may be accommodated by the invention, using appropriate design criteria.

The geometry of the eccentric cams provides for an “over center” cam surface contact with flange 165, when rotated to the closed position, by which the resistance of the joint and seal to the compression tends to hold the cams and cam levers in the closed position.

Referring to FIG. 2, there is depicted a cross-sectional view of one embodiment of the invention with cams 120 in the locking or coupled position. As in FIG. 1, connector body 100 is shown securing first fitting 150 and second fitting 160. A sealing gasket 170 is shown between the abutting ends of the two fittings. A gasket may be replaced or supplemented by other sealing means. Fitting 150 is retained within body 100 by threaded section 140, which consists of external threads on fitting 150 that match internal threads on body 100. The threaded section 140 provides for pre-setting and/or final adjustment of the depth of fitting 160 into body 100, which affects cam locking compression. A lock nut, set screw, or other common means (not shown) may be provided to secure the adjustment of depth of fitting 150 in body 100, either before or after the coupling is locked onto a second fitting. In other embodiments, threads may be replaced by other attachment mechanisms. This may include, but not be limited to, one or more projections from the interior surface of the connector body. Projections may be or include a raised rim or rib portion, or one or more pins or screws. Such attachment means may or may not provide for adjustment to the length or depth of insertion of fitting 150 into body 100, by which a pre-set or final adjustment for the butt joint compression may be accomplished.

Referring still to FIG. 2, as in the embodiment of FIG. 1, eccentric cam 120 and cam lever 130 rotates about pivot pin 110 to secure eccentric cam 120 against a flange of second fitting 160. Cam levers are illustrated in a locked position. There may be in this or in other embodiments a supplemental means to secure each or all of the cam levers in the closed position, so as to avoid unintentional or accidental release of one or more cams. In this embodiment, lever latch holes 136 have corresponding connector latch holes 106, that come into alignment when the levers are moved to the locking position. Many other ways are possible and all are within the scope of the invention. For example, there may be a sliding collar (not shown) that is slipped forward from or on first fitting 150 to enclose the distal ends of the cam levers. Or for example there may be a simple strap, hook, pin, catch, or other common keeper (not shown) for each lever, that connects the lever to the coupler body, fitting 150, or to the tube installed on it. Or there may be a strap that is wrapped around the coupler and fitting and all the levers, secured as by a snap, clip, or hook and eye fastener material to hold the levers in the closed or locked position.

Referring now to FIG. 3, there is illustrated a cross sectional view of an embodiment of a sanitary quick connector, depicted with cams 120 in an unlocked position such that the sanitary quick connector could be withdrawn from second sanitary fitting 160. As in FIGS. 1 and 2, connector body 100 of this sanitary quick connector is shown engaged with first fitting 150 and joining it to second fitting 160. A single sealing gasket 170 is in place between flanges of the respective fittings. The cross section of gasket 170 includes an industry standard circular section in this example, but other cross sections are within the scope of the invention. The circular section of industry standard gasket 170 is illustrated as confined within matching semicircular recesses 156 and 166 let into the face of each fitting Fitting 150 is retained within body 100 by threaded portion 140. Cam lever 130 rotates about pivot pin 110 to secure eccentric cam 120 against the backside of flange 165 of second fitting 160.

It should be further apparent from the FIG. 3 illustration that where the sanitary quick connector and the second fitting are both round in accordance with industry standards, there is no required rotational orientation of the connector body with respect to the fitting to which it is being coupled. The cams will lock on the flange irrespective of rotational orientation, and further, the connector body can be rotated with respect to the fitting during or after the connection is made and locked, the cams sliding along on the backside of the flange. Cams 120 in some embodiments may be configured at their cam contact end with roller or ball tips (not shown) that bear as bearings on the backside of flange 165, to facilitate either or both the cam locking action and the ease with which the connector body may be rotated on the fitting with less abrasion or wear to the flange backside surface or the cam surface, as when adjusting the compression.

It should also be readily apparent to those skilled in the art that keying between the coupler body and the fitting or fittings to which it will be coupled, may be provided by several common means such that one or more rotational orientations of the connector body to the second fitting is required, or conversely, must be avoided. The keying structure may be external or internal to the connector body, and integral to or external of the fitting to which it will be coupled.

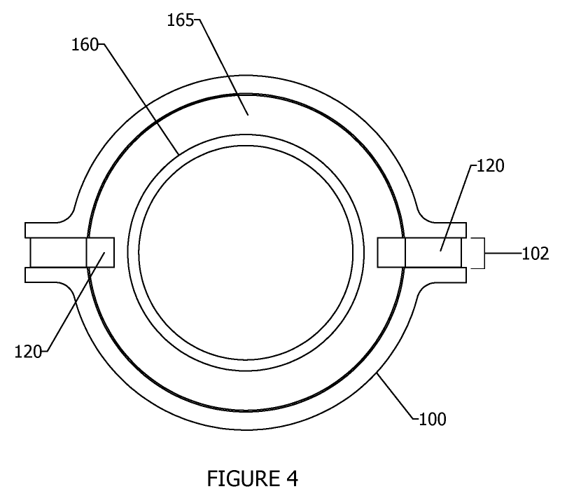

Referring now to FIG. 4, there is illustrated an end view of a connector body 100 of the invention configured with two cams 120 arranged 180 degrees apart on the connector body, coupled to a second fitting 160 so that the cams 120 extend over and pull on the backside of flange 165 of the fitting. It should be noted that in other embodiments there may be more than two cams, and that they may be equally or unequally spaced around the connector body.

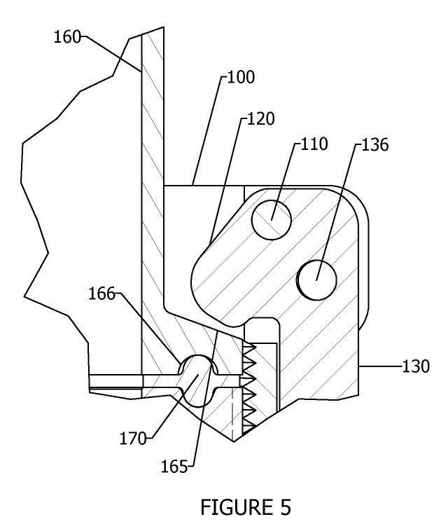

Referring now to FIG. 5, there is illustrated a detail sectional view of a cam of one embodiment of a sanitary quick connector in a locked position over the flange of a sanitary fitting. As in previous figures, connector body 100 is shown enclosing flange 165 of second fitting 160. A portion of sealing gasket 170 is shown. Cam lever 130 rotates about pivot pin 110 to secure eccentric cam 120 against a flange of second fitting 160.

Other and various embodiments are within the scope of the invention. For example, the opposing faces of the butt joint of the connection may be planar or conical, and have or not have matching profiles. A mismatch of face end profiles may be accommodated by a conforming or conformable gasket. One or both faces of the mating fitting may have a circular recess of a rectangular or semi-circular profile or be otherwise keyed or configured so as to accept the placement of a suitable seal or gasket of desired material, profile, and thickness. The gasket profile may by design accommodate non-matching mating surface profiles as for example by incorporating the equivalent of an O-ring in the otherwise flat gasket profile that matches a corresponding semi-circular groove in each fitting end.

The interface geometry of the first fitting 150 and connector body 100 requires sufficient wall thickness of the fitting and of the connector body to support their connection, in whatever form it takes. For example, for a threaded section, screw-type interface as illustrated, wall thickness must allow for their respective thread depth or cut as well as supporting the connection forces and the maximum allowable fluid line pressure. A threaded interface design must also include consideration of an appropriate thread size, pitch, and number of turns in the connector body for axial engagement and for a useful range of compression adjustment relative to a unit of rotation of one with respect to the other. Also, first fitting 150 must have a minimum acceptable number of threads or turns by which the first fitting will be properly supported within the connector body.

The threaded connection between connector 100 and first fitting 150 provides for adjustment of the compression force on the union or joint with the flanged second sanitary fitting by rotating the first fitting with respect to the connector body, or alternatively, rotating the connector body with respect to the first fitting. In a keyed embodiment where the connector body is keyed to the second fitting 160, and this second fitting is installed in or extends from a stationary manifold of some type so as to be resistant to manually applied rotation forces, the connector body cannot be rotated with respect to the second fitting when coupled to it. In this case, joint compression may be adjusted after the fluid connection is made by rotating the first fitting and attached hose, assuming sufficient flexibility, within the connector body to a torque level representative of an appropriate compression force on the seal or gasket.

In some embodiments, first fitting 150 is pre-positioned for the correct depth within connector body 100 for making a connection or coupling of nominally acceptable compression to an industry standard second sanitary fitting. The connection is then made and compression adjusted as described above. Alternatively, the rotational pre-set adjustment may be locked with a locking set screw or locking nut (not shown) or other means to avoid further manual rotation affecting compression, during normal use of the quick connector. A further alternative provides for any commonly used means for rotationally locking the connector body to the first fitting, to be applied after the final, post coupling, compression adjustment.

Referring to the figures and restating the above adjusting means, after a rotational pre-set for compression is made and after the connection with second fitting 160 is made and the cam levers are swung to the locked position, a final rotational adjustment of first fitting 150 may be made with respect to the connector body 100, or vice versa, to achieve a desired amount of torque equated by the operator to a desired amount of compressive force on the connector seal or gasket.

There may also be a slide lock, clip, pin, locking ring or screw or locking pall (not shown) or other mechanism associated with the connector body and first fitting that is easily manually set after the final rotational adjustment to prevent further rotation of the first fitting in one or both directions within the connector body. A ratchet action mechanism that accepts advancing rotation of fitting 150 but prevents counter rotation within body 100 unless or until released is within the scope of this aspect of the invention.

In an alternative, unitary embodiment where the first fitting and connector body are integrated, accepting by definition that fluid will contact the interior wall of the connector body in this case but is otherwise normally contained, the connector body 100 may incorporate a permanent abutting flange or surface for the face-gasket-face union connection to flange 165 of the second fitting, and a short nipple or tubular tailpiece extension or structure by which a hose or tube can be attached by a hose clamp or other common means, or by which a compression or other type union or pipe joint may be used to join it to a further length of fitting, pipe or hose or otherwise connect it to a fluid distribution system or container. Cams 120 and supporting structure are in this embodiment integral to the connector body, but external to the fluid flow or fluid channel when the fluid connection is established. The cam mechanism may in these embodiments provide for cam action adjustment as by limiting rotation of the cam or adjusting the point of rotation, thereby affecting joint compression.

With respect to the second, industry standard fitting 160, the strength and rigidity of the second fitting, and in particular its flange 165, is relied upon to extend the contact point pressure of the two or more eccentric cams on flange 165, uniformly around the gasket and the joint generally, so as to maintain joint integrity. As noted with respect to the first fitting 150, second fitting 160 may likewise or in the alternative be or include a connection to a fluid distribution system or container.

Although two eccentric cams and cam levers on connector body 100 are in several embodiments illustrated for locking down flange 165, a greater number of eccentric cams and cam levers distributed about the connector body, may be employed. In all cases, the pivot pins or mechanisms on or by which the cams are rotated are calculated to carry the forces relating to the design limits for exerting the maximum desired force of compression, as well as accommodate the rotational functionality required of the cam levers for locking and unlocking the connection.

In possible variations to the otherwise industry standard second fittings, flange 165 may comprise or be configured with a pair or series of formed flange segments or locking recesses, radially spaced about the butt end of second fitting 160 whereby connector body 100 is rotationally adjusted to align the cams with the locking recesses during connecting operations, and the connection then formed and locked in the same manner described above.

The invention is susceptible of other and numerous embodiments, variations and applications. As an example, there are connectors for the transfer of fluids, including various liquids, air, steam, and other process gases. Such connectors may consist of a body having an interior surface defining an axially extending passage between a first end and a second end of the body, where the passage is sized so that one end of a first fluid conductor and one end of a second fluid conductor can be disposed within the passage with a sealing material disposed between them, thereby forming a circular butt joint relationship between the fluid conductors so as to permit fluid flow there between without contacting the connector body. There may be a fastening means whereby a depth of insertion of the first fluid conductor within the body may be adjusted and the first fluid conductor secured within the body. There may be a sealing material formed and sized as a gasket or seal that mates with the respective abutting ends of the fluid conductors. And it may include a cam locking mechanism that includes at least two eccentric cams uniformly distributed around the body and pivotally mounted on or to the body with externally accessible cam levers whereby the second fluid conductor can be inserted and locked by cam action within the passage of the body in compressive contact with the sealing material and hence with the first fluid conductor.

As another example, there is a sanitary fluid connector for coupling a sanitary fluid system to a flanged sanitary fluid fitting that includes a first sanitary fluid fitting having a mating end configured with external screw threads and a flat face. The flat face is further adapted to receive a sanitary fluid connector gasket and be mated to a flanged sanitary fluid connector. The first fitting has a back end adapted to accept attachment to a sanitary fluid system which might be or include a fluid hose or line, or a fluid reservoir or source or pump, or a fluid manifold further connected to a fluid source or such.

The connector also includes a connector body with an interior surface defining an axially extending passage between a back end and a coupling end of the body, where the passage proximate the back end of the body is sized and configured with threads by which the mating end of the first sanitary fluid fitting may be adjustably engaged within the passage to a selected depth by rotation of the body with respect to the first sanitary fluid fitting. The coupling end of the connector body is configured with a cam locking mechanism that includes at least two eccentric cams uniformly distributed around the body and pivotally mounted on the body for rotation through respective slots into and out of the passage. The cams are configured with externally accessible cam operating levers, whereby a mating flange on a flanged second sanitary fluid fitting of the type described previously may be locked by operation of the cams to create a sanitary fluid flow path or connection with the first sanitary fluid fitting.

The body may be fabricated of stainless steel. The connector or parts of it may be fabricated of at least one of a group of materials consisting of stainless steel, ceramic, and plastic material, each of which is known to those skilled in the art to have useful properties for a device of this nature. And the flat face of the first sanitary fluid fitting may have a semi-circular recess for receiving a raised, semicircular rib on one face of a sanitary fluid connector gasket.

As yet another example, there is a sanitary fluid connector for coupling a sanitary fluid system to a flanged sanitary fluid fitting that includes a first sanitary fluid fitting having a mating end configured with a flat face, the flat face further adapted to receive a sanitary fluid connector gasket and be mated to a flanged sanitary fluid connector, and a back end adapted to accept attachment to a sanitary fluid system. It also has a connector body having an interior surface defining an axially extending passage between a back end and a coupling end of the body, where the passage proximate the back end is sized and configured with any common means for receiving and securing the mating end of the first sanitary fluid fitting therein, which might be any of adhesives, press fit, spring washer, any of several types of common fasteners including pins, screws, and locking flanges. The coupling end of the connector body is configured with at least two eccentric cams pivotally mounted thereon for rotation through respective slots into and out of the passage, at least two of the cams configured with externally accessible cam operating levers.

Any of the above examples may include means for locking the first sanitary fluid fitting within the passage in the connector body so as to inhibit further rotational adjustment or other relative movement.

As still another example, there is a sanitary fluid line connector for coupling a sanitary fluid system to a flanged end sanitary fluid fitting, consisting of a connector body configured with an interior surface defining an axially extending passage between a back end and a coupling end of the connector body, where the back end is adapted to accept attachment to a sanitary fluid system, and the passage is configured with a flat face further adapted to receive a sanitary fluid connector gasket and be mated to a flanged sanitary fluid connector received through the coupling end of the connector body. The coupling end of the connector body is configured with a cam locking mechanism including at least two eccentric cams pivotally mounted thereon for rotation through respective slots in the connector body into and out of the passage. The cams are configured with at least two externally accessible cam operating levers, whereby a flexible fluid line or other connection to a sanitary fluid system may be attached to or integrated with the back end of the connector body and the connector body may be positioned with respect to a second sanitary fluid fitting configured with a mating flange so as to receive the mating flange through the coupling end into the passage into contact with the sanitary fluid connector gasket and hence with the flat face in the passage. The cams are rotable thereafter so as to lock the connector body to the second sanitary fluid fitting for fluid flow.

As will be readily appreciated by those skilled in the art and needs no illustration, any of the previous examples may be further configured with cam springs whereby the cams are configured to have to be pushed outward or open by coupling action or by manual operation of the cam levers in order to overcome the spring force, and are biased to return by spring force to a locking position once the opening force is withdrawn, as by full seating of the second fitting within the connector body, or withdrawal of the second fitting from within the connector body. Alternatively, the cams and cam levers may be biased to return to a normally open position, and require a force opposing the spring force for locking. In addition or in the alternative, there may be an automatic latching mechanism that latches the cam levers in the locked position whenever they are placed there, and holds the cam levers in the locked position until released. The latching mechanism may be configured to release each cam lever independently or to release all of them collectively.

Other and numerous embodiments, examples, and equivalents within the scope of the appended claims will be readily apparent to those skilled in the art from this description and the accompanying figures.

I claim:

1. A sanitary fluid connector for coupling a sanitary fluid system to a flanged sanitary fluid fitting, comprising:
a first sanitary fluid fitting having a mating end configured with external screw threads and a flat face, the flat face further adapted to receive a sanitary fluid connector gasket and be mated to a flanged sanitary fluid connector, and a back end adapted to accept attachment to a sanitary fluid system; and
a connector body having an interior surface defining an axially extending passage between a back end and a coupling end of said body, said passage proximate said back end being sized and configured with threads by which the mating end of said first sanitary fluid fitting may be adjustably engaged within said passage to a selected depth by rotation of said body with respect to said first sanitary fluid fitting, the coupling end of said connector body being configured with a cam locking mechanism including at least two eccentric cams uniformly distributed around said body and pivotally mounted thereon for rotation through respective slots into and out of said passage, said cams configured with externally accessible cam operating levers, whereby a mating flange on a flanged second sanitary fluid fitting may be locked by operation of said cams into a sanitary fluid flow connection with said first sanitary fluid fitting.

2. The sanitary fluid connector of claim 1, said at least two eccentric cams comprising two eccentric cams, each said cam configured with a said externally accessible cam operating lever.

3. The sanitary fluid connector of claim 1, said body fabricated of stainless steel.

4. The sanitary fluid connector of claim 1, said connector fabricated of at least one of a group of materials consisting of stainless steel, ceramic, and plastic material.

5. The sanitary fluid connector of claim 1, further comprising said sanitary fluid connector gasket.

6. The sanitary fluid connector of claim 5, said flat face of said first sanitary fluid fitting comprising a semi-circular recess for receiving a raised, semicircular rib on one face of said sanitary fluid connector gasket.

7. A sanitary fluid connector for coupling a sanitary fluid system to a flanged sanitary fluid fitting, comprising:
a first sanitary fluid fitting having a mating end configured with a flat face, the flat face further adapted to receive a sanitary fluid connector gasket and be mated to a flanged sanitary fluid connector, and a back end adapted to accept attachment to a sanitary fluid system; and
a connector body having an interior surface defining an axially extending passage between a back end and a coupling end of said body, said passage proximate said back end being sized and configured with means for receiving and securing the mating end of said first sanitary fluid fitting therein, the coupling end of said connector body being configured with at least two eccentric cams pivotally mounted thereon for rotation through respective slots into and out of said passage, at least two of said cams configured with externally accessible cam operating levers.

8. The sanitary fluid connector of claim 7, said means for receiving and securing the mating end of said first sanitary fluid fitting comprising the mating end of the first sanitary fluid fitting being configured with external threads, and the connector body being configured with matching internal threads by which the external threads on the first sanitary fluid fitting may be adjustably engaged within the passage to a selected depth by rotation of the body with respect to the first sanitary fluid fitting.

9. The sanitary fluid connector of claim 8, further comprising means for locking the first sanitary fluid fitting within the passage in the connector body so as to inhibit further rotational adjustment.

10. The sanitary fluid connector of claim 8, said connector body and said first sanitary fluid fitting being fabricated of stainless steel.

11. The sanitary fluid connector of claim 1, said connector body being fabricated of ceramic materials.

12. The sanitary fluid connector of claim 7, said connector body being fabricated of ceramic materials.

13. The sanitary fluid connector of claim 1, said connector body being fabricated of plastic.

14. The sanitary fluid connector of claim 7, said connector body being fabricated of plastic.

15. A sanitary fluid line connector for coupling a sanitary fluid system to a flanged end sanitary fluid fitting, comprising a connector body configured with an interior surface defining an axially extending passage between a back end and a coupling end of said connector body, said back end adapted to accept attachment to a sanitary fluid system, said passage configured with flat face further adapted to receive a sanitary fluid connector gasket and be mated to a flanged sanitary fluid connector received through the coupling end of the connector body, the coupling end of said connector body being configured with a cam locking mechanism including at least two eccentric cams pivotally mounted thereon for rotation through respective slots in said connector body into and out of said passage, said cams configured with at least two externally accessible cam operating levers, whereby a sanitary fluid system may be attached to the back end of said connector body and said connector body may be positioned with respect to a second sanitary fluid fitting configured with a mating flange so as to receive the mating flange through the coupling end into the passage into contact with the sanitary fluid connector gasket and hence with the flat face in the passage, said cams being rotable thereafter so as to lock said connector body to said second sanitary fluid fitting for fluid flow.

16. The sanitary fluid line connector of claim 15, configured of stainless steel.

17. The sanitary fluid line connector of claim 15, configured of ceramic material.

18. The sanitary fluid line connector of claim 15, said flat face comprising a semi-circular recess for receiving a raised, semicircular rib on one face of said sanitary fluid connector gasket.

19. The sanitary fluid connector of claim 1, said connector body further configured with cam springs whereby said cams are configured to be pushed outward by coupling action and are spring biased to return to a locking position.

20. The sanitary fluid connector of claim 15, said connector body further configured with cam springs whereby said cams are configured to be pushed outward by coupling action and are spring biased to return to a locking position.
